(19) United States
(12) Patent Application Publication
(10) Pub. No.: US 2011/0148965 A1
(43) Pub. Date: Jun. 23, 2011

(54) INKJET PRINTING APPARATUS AND RECOVERY METHOD

(75) Inventors: Hiroshi Taira, Chofu-shi (JP); Hidehiko Kanda, Yokohama-shi (JP); Akiko Maru, Tokyo (JP); Hirokazu Yoshikawa, Yokohama-shi (JP); Kenichi Oonuki, Kawasaki-shi (JP)

(73) Assignee: CANON KABUSHIKI KAISHA, Tokyo (JP)

(21) Appl. No.: 12/955,541

(22) Filed: Nov. 29, 2010

(30) Foreign Application Priority Data
Dec. 18, 2009 (JP) 2009-287540

(51) Int. Cl. B41J 29/38

(52) U.S. Cl. 347/14

(57) ABSTRACT

An inkjet printing apparatus of the present invention is equipped with a recovery device for recovering an ink ejection state of a print head. The print head has a plurality of nozzle rows each for ejecting an ink of a different color, and a nozzle surface. The recovery device performs wiping of the nozzle surface and preliminary ejection from the print head. After the wiping, an evaluation patch is created by performing the preliminary ejection onto a printing medium, and the number of preliminary ejections of a specific nozzle is increased to a number larger the number of preliminary ejections of other nozzles based on an image of the evaluation patch. It is possible to appropriately decide the number of preliminary ejections for each nozzle according to color mixture parts that vary for every apparatus.

### BACKGROUND OF THE INVENTION

1. Field of the Invention

The present invention relates to an inkjet printing apparatus for performing printing on a printing medium by ejecting inks, and a recovery method.

2. Description of the Related Art

The inkjet printing apparatus ejects droplets of the inks from a plurality of nozzles (or ejection openings) of a print head using an electric heat conversion element or an electric mechanical conversion element, and prints an image on the printing medium such as paper.

In addition, the inkjet printing apparatus is equipped with a recovery device for recovering and maintaining ink ejection performance of the print head. This recovery device is normally equipped with a wiping device for removing inks, dust, etc. adhering to a nozzle surface by wiping them off. Moreover, the recovery device is equipped with a preliminary ejection unit for ejecting inks that do not participate in a printing processing (this is called preliminary ejection) from the nozzles to refresh the inks in the nozzles.

Incidentally, in the case of a print head that is provided with a plurality of nozzle rows each ejecting an ink of a different color, such as a print head for color printing, there is a problem that color mixture occurs immediately after the wiping and deteriorates an image quality. That is, execution of the wiping will push color-mixed inks adhering to the nozzle surface in a reverse flow direction into the interiors of the nozzles. Then, there may be a case where in a subsequent printing operation, the color of the printed image in an early stage of printing start will become different from a setup color and a quality of the printed image will be deteriorated.

Then, as a measure against this, the preliminary ejection of the predetermined number of shots is performed immediately after the wiping. When doing this, mixed color inks are discharged from the nozzles at the time of execution of the preliminary ejection, which makes it possible to suppress or prevent deterioration of the image quality at the early stage of printing start.

Incidentally, since the preliminary ejection is a processing of simply discarding the inks, it is desirable to lessen the number of preliminary ejections as less as possible. On the other hand, if the number of preliminary ejections is too small, the mixed color inks cannot be ejected fully, so that image quality deterioration will be caused. Therefore, it is desirable to lessen the number of preliminary ejections as less as possible in a range in which the mixed color inks can be fully discharged.

As a technique of reducing the number of preliminary ejections, there is one that is disclosed in Japanese Patent Laid-Open No. H08-058109 (1996), for example. This is a technique of performing the preliminary ejection from all the nozzles and the preliminary ejection from nozzles on ends of the nozzle row alternately. In view of an examination result that a degree of the color mixture is more remarkable in the end parts than in the central part of the nozzle row, the number of preliminary ejections is increased larger in the end parts than in the central part of the nozzle row. Conversely, the number of preliminary ejections is decreased smaller in the central part than in the end parts of the nozzle row.

However, a portion where the degree of the color mixture is large does not necessarily exist in the end parts of the nozzle row, and it is considered that it varies for each apparatus. Therefore, it is difficult to say that the method of always increasing the number of preliminary ejections as the Japanese Patent Laid-open No. H08-058109 (1996) is necessarily sufficient in terms of compatibility of an excellent image quality and decrease of the amount of waste inks.

For example, the recovery device controls so that a wiping blade may be operated at a constant speed in order to eliminate wiping unevenness in the wiping. However, because of friction by interference with a holder and the head etc., and because of occurrence of variation of a load in a mechanical mechanism (a cam, a spring, etc.) during a wiping operation, an actual speed of the blade varies in connection with these. As a result, the wiping unevenness by chatter called stick slip occurs, which produces a portion where the degree of the color mixture is large and a portion where it is small (including a portion where no color mixture exists).

At this time, since the same apparatus has the same load variation, a mark of chatter remains even when a plurality of times of wiping are performed, and an almost fixed portion has a large degree of the color mixture. However, a way in which the load varies in each apparatus is different due to variation of a part, etc. Therefore, a portion where the degree of the color mixture is large varies in a different apparatus. In this way, a portion where the degree of the color mixture is large varies for every apparatus.

The present invention is invented in view of this situation. Its object is to provide an inkjet printing apparatus and a recovery method that can achieve compatibility of an excellent image quality and decrease of the amount of waste inks by appropriately deciding the number of preliminary ejections of each nozzle according to the color mixture parts that vary for every apparatus.

### SUMMARY OF THE INVENTION

An aspect of the present invention provides an ink jet printing apparatus including:
a printing section configured to perform printing using a print head with a plurality of nozzle rows formed in a nozzle surface and through which ink in different colors is ejected;
a wiping device configured to wipe the nozzle surface in the print head;
a preliminary ejection unit configured to preliminarily eject ink from the print head;
a patch printing unit configured to print an evaluation patch on a print medium using a predetermined one of the plurality of nozzle rows after the wiping is carried out; and
a determination unit configured to determine the number of preliminary ejections for every predetermined number of nozzles in the predetermined nozzle row based on the evaluation patch.

Another aspect of the present invention provides a recovery method of recovering an ink ejection state of a print head with a plurality of nozzle rows formed in a nozzle surface and through which ink in different colors is ejected, the method including:
wiping the nozzle surface in the print head with a wiping device;
after the wiping, printing an evaluation patch on a print medium using a predetermined one of the plurality of nozzle rows; and
based on the number of preliminary ejections determined based on the evaluation patch, carrying out a preliminary ejection for every predetermined number of nozzles in the predetermined nozzle row.

According to the present invention, there are exerted excellent effects as follows: appropriately deciding the number of preliminary ejections of each nozzle according to the color mixture parts that vary for every apparatus; and capability of achieving excellent image quality and reduction of quantity of waste ink.

Further features of the present invention will become apparent from the following description of exemplary embodiments (with reference to the attached drawings).

### BRIEF DESCRIPTION OF THE DRAWINGS

FIG. 1 is a perspective diagram of an inkjet printing apparatus according to an embodiment of the present invention;

FIG. 2 is a diagram showing a nozzle surface of a print head;

FIG. 3 is a schematic diagram of a recovery device;

FIG. 4 is a block diagram showing a configuration of a control system of the inkjet printing apparatus;

FIG. 5 is a flowchart of a preliminary ejection count decision processing;

FIG. 6 is a diagram showing an image of an evaluation patch;

FIG. 7 is a flowchart of a color mixture determination processing;

FIG. 8 is a diagram showing details of a divided area P_6_2 shown in FIG. 6;

FIG. 9 is a diagram showing details of a divided area P_0_3 shown in FIG. 6;

FIG. 10 is a diagram showing a color mixture determination result of each divided area; and

FIG. 11 is a graph showing a result that the number of preliminary ejections is decided from the result of FIG. 10.

### DESCRIPTION OF THE EMBODIMENTS

Hereafter, with reference to drawings, an embodiment of the present invention will be explained specifically.

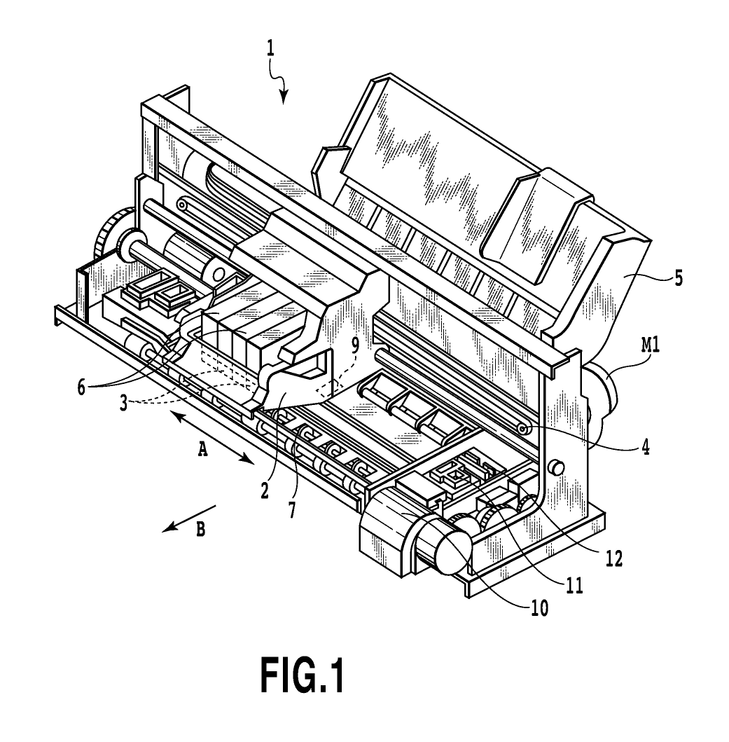

FIG. 1 is a perspective diagram of the inkjet printing apparatus according to this embodiment, showing a state where a case cover is removed. The inkjet printing apparatus 1 is equipped with a movable carriage 2 that carries a print head 3, and carriage motor M1 and driving mechanism 4 for making the carriage 2 do reciprocating movement in a scanning direction A. Moreover, it is equipped with a paper feeding mechanism 5 for supplying a printing medium (not illustrated), such as paper, and a recovery device (recovery means) 10 for performing a recovery processing of the print head 3.

The print head 3 is provided at a bottom part of the carriage 2, as in one piece. Moreover, a plurality of ink tanks (also called ink cartridges) 6 are mounted on the carriage 2 detachably. An ink in the ink cartridge 6 is supplied to the print head 3. The inkjet printing apparatus 1 is configured so that the printing medium, in a state of mounting on a platen, may be conveyed in a vertical scanning direction below the print head 3. The printing medium is conveyed by a conveyance motor and a conveying roller 7. The scanning direction A and the vertical scanning direction B are perpendicular to each other.

The print head 3 prints an image on the printing medium by ejecting the inks based on an image signal. The inkjet printing apparatus continues to print an image equivalent to one band on the printing medium by giving a drive signal based on the image signal to the print head 3 in synchronization with at least one of outward and return movements of the carriage 2. After the printing for even one band is finished, the printing medium is conveyed by a width equal to the even one band and halted. Once more, the carriage 2 is moved and the printing for the next even one band is performed. An image is formed on the printing medium by alternately repeating a printing operation and a conveyance operation like this. The printing medium that finished the printing is discharged from the apparatus body by the conveying roller 7.

The print head 3 is for color printing, and four ink cartridges 6 that house a plurality of kinds of inks, namely inks of respective colors of black (K), cyan (C), magenta (M), and yellow (Y) are mounted on the carriage 2. These four ink cartridges are independently detachable and exchangeable, respectively.

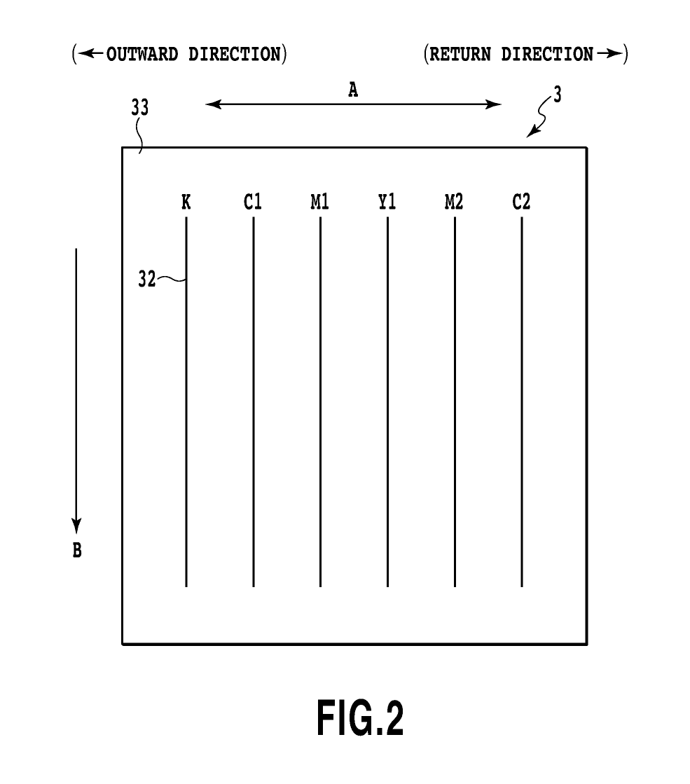

FIG. 2 shows a bottom part of the print head 3 provided at the bottom part of the carriage 2. As shown in the figure, a plurality of nozzle rows 32 are formed in the print head 3. The each nozzle row 32 is constructed with a plurality of nozzles (also called ejection ports) for ejecting inks and arranged in a line along the vertical scanning direction B In this embodiment, total six nozzle rows 32 are formed. A surface on which output ports of these nozzle rows are opened is designated by a nozzle surface 33 of the print head 3. During the printing operation, the nozzle rows 32 and the nozzle surface 33 are located above the printing medium and are set downward facing the printing medium.

In the figure, a symbol Y1 designates the nozzle row 32 for ejecting yellow ink. Similarly, M1 and M2 designate nozzle rows of magenta, C1 and C2 designate nozzle rows of cyan, and K designates a nozzle row of black, respectively. In the each nozzle row 32, nozzles are arranged with a predetermined nozzle density (dpi). The nozzle rows 32 are mutually in parallel, and are prolonged in the vertical scanning direction B.

In the case of this embodiment, the nozzle rows of cyan and magenta are arranged symmetrically in a main scanning direction in the figure, as in a configuration of black, cyan, magenta, yellow, magenta, and cyan from the left. Performing the printing with such an arrangement makes it possible to give the inks in the same order in the scanning of the carriage reciprocating in both of an outward direction and a return direction. Therefore, a difference in coloring accompanying a difference of a giving order of the inks does not appear between the image printed by outward scanning and the image printed by return scanning, so that it becomes possible to output a color image at high speed.

Although not illustrated, each nozzle is made to communicate with a corresponding ink tank 6 through an ink channel, the ink is always filled therein near the nozzle by supply of the ink from the ink tank 6. The print head 3 is provided with electric heat transfer elements, namely heaters, for the respective nozzles. When a driving voltage or driving pulse is applied to this heater, air bubbles are generated in the ink by thermal energy that the heater generates. Then, a generated pressure of these air bubbles pushes the ink in the nozzle by a predetermined quantity, which performs ink ejection. Although, in this embodiment, the print head is specified to be one that ejects the ink by the bubble jet method, the print head may be one that ejects the ink by an other ejection method, such as the piezoelectric method. Moreover, the print head may be one that has different cases for respective ink colors or respective nozzle rows. Furthermore, the carriage 2 includes a scanner 9 configured to scan an image printed on a print medium.

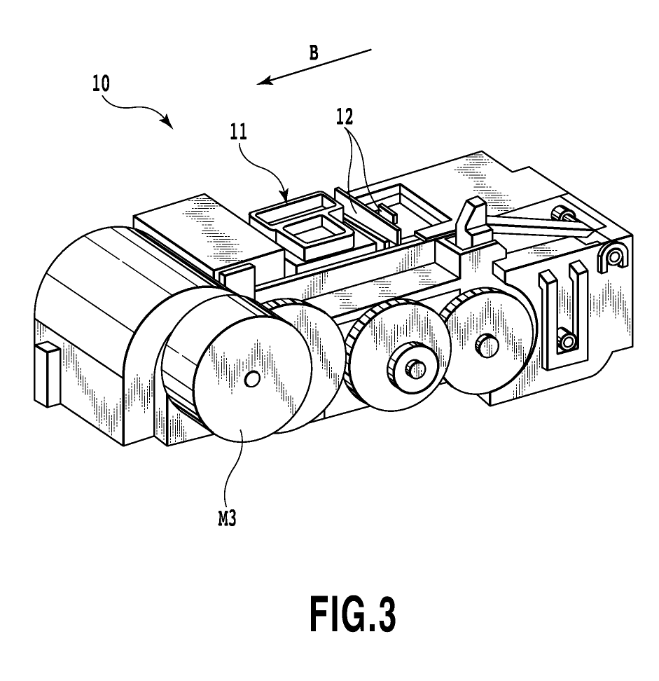

Returning to FIG. 1, the inkjet printing apparatus is provided with the recovery device (recovery means) 10 for recovering an ink ejection state of the print head 3. As shown in FIG. 3, the recovery device 10 includes a wiping device 12 (wiping means) for wiping off the inks (performing wiping), dusts, etc. adhering to the nozzle surface 33 of the print head 3. Furthermore, the recovery device 10 includes a capping device 11 capable of adhering closely to the nozzle surface and covering all the nozzle rows 32 (namely, performing capping). The wiping device 12 and the capping device 11 are placed below a home position of the carriage 2 that does not perform the printing operation in the scanning direction A. The capping device 11 has also a function as an ink receiver at the time of the preliminary ejection. Furthermore, the recovery device 10 also includes a suction unit (suction means) for compulsorily sucking and discharging the inks from the nozzles using a negative pressure sucking force by a suction pump etc, in a capping state.

The capping device 11 includes a rectangular-frame-like cap main body that can be tightly contacted with the nozzle surface 33 outside all the nozzle rows 32 and an absorber accommodated in the cap main body . For example, the cap main body is formed of an elastic body such as rubber. The absorber is formed of a porous material such as a sponge. The capping device 11 also functions as an ink receiver during preliminary ejection. The preliminary ejection allows ink (particularly mixed color ink) and bubbles in each nozzle and ink passage to be discharged and removed.

The wiping device 12 includes a wiping blade formed of rubber and a base member configured to support the wiping blade. The wiping deice 12 is slid in the sub-scanning direction B by switching the driving source for the recovery device 10 to drive the motor M3 inside the recovery device. In the present example, the nozzle row 32 extends in the sub-scanning direction B. Thus, the wiping is performed in the direction of the nozzle row 32.

The recovery device 10 is configured to carry out a recovery process using an appropriate combination of the capping device 11, the wiping device 12, and the suction device, to maintain or recover the normal state of the ink ejection performance of the print head 3.

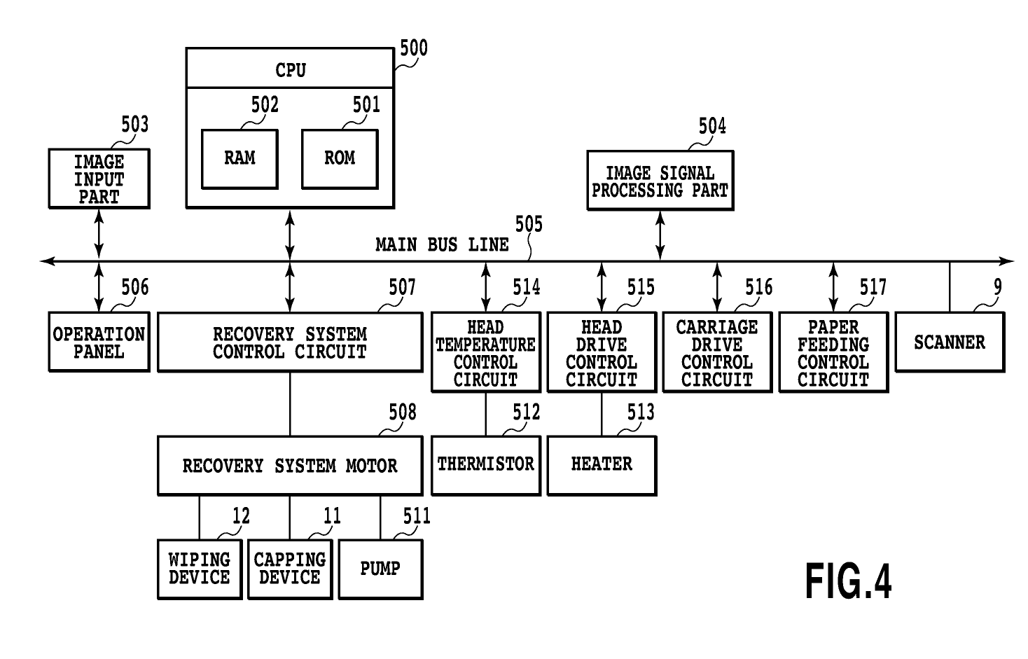

FIG. 4 shows a configuration of a control system of the inkjet printing apparatus. A CPU 500 performs a control and a data processing of each part of the apparatus through a main bus line 505. That is, the CPU 500 controls the data processing, head drive, and carriage drive in accordance with a program stored in ROM 501 through respective parts below. RAM 502 is used as a work area for the data processing by the CPU 500, etc. In addition to these pieces of memory, there is a storage unit of a hard disk drive, etc. An image input part 503 has an interface with a host device, and temporarily holds an image inputted from the host device. An image signal processing part 504 performs the data processing such as color conversion and binarization. Moreover, the image signal processing part 504 processes data of the image scanned by the scanner 9.

An operation panel 506 is equipped with keys, etc., which make possible inputting by an operator, etc. A recovery system control circuit 507 controls recovery operations, such as the preliminary ejection and the wiping in accordance with a recovery processing program stored in the RAM 502. A recovery system motor 508 drives the wiping device 12, the capping device 11, a suction pump 511, etc. at the time of the recovery processing. A head drive control circuit 515 controls heaters 513 of the respective nozzles of the print head 3 individually, and makes the print head 3 perform the ink ejection for normal printing and the preliminary ejection. Furthermore, a carriage drive control circuit 516 and a paper feeding control circuit 517 similarly control a movement of the carriage and paper feeding, respectively, in accordance with the program.

The print head 3 is providedwitha temperature keeping heater for keeping a ink temperature in the print head 3 at a predetermined temperature, and a thermistor 512 for detecting the ink temperature in the print head 3. A head temperature control circuit 514 controls the temperature keeping heater based on a detection signal from the thermistor 512.

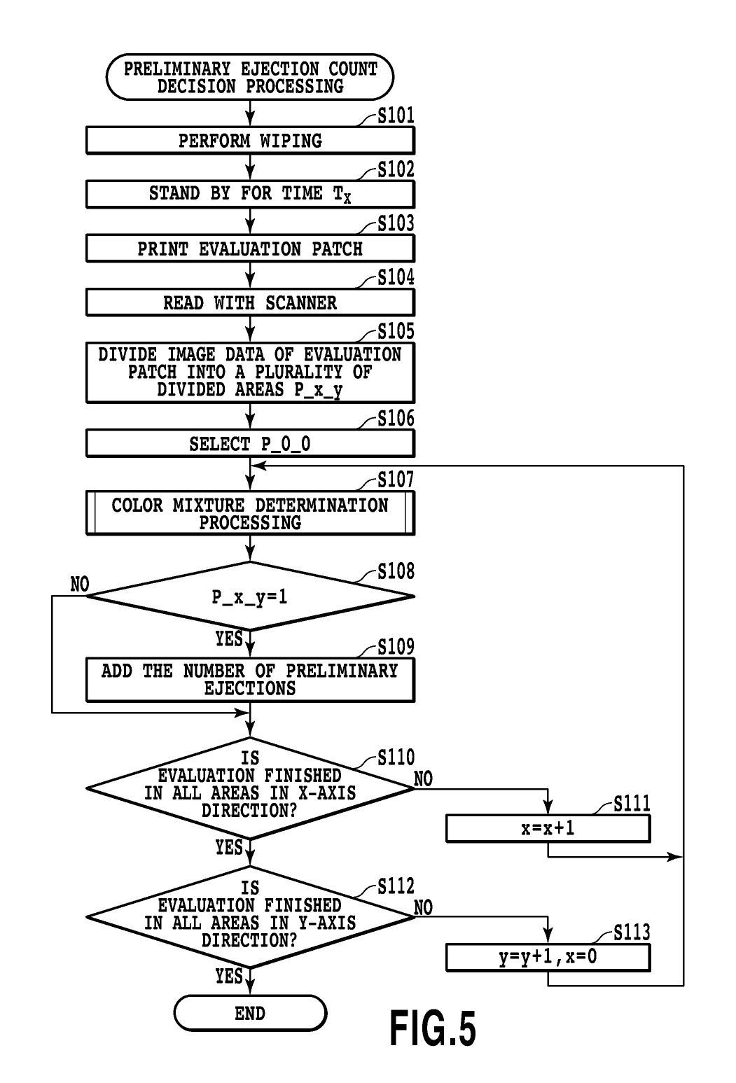

Next, a processing for deciding the number of preliminary ejections (namely, the number of ink droplet ejections) in the preliminary ejection will be explained referring to FIG. 5. The processing is performed mainly by the CPU 500.

First, at Step S101, the wiping by the wiping device 12 is performed. At this time, there may be a case where chatter arises in connection with speed fluctuation at the time of the wiping, and the mixed color inks adhere to the nozzle surface 33 perpendicularly to the nozzle rows 33 thereof.

After execution of this wiping, at Step S102, the flow becomes in a standby state for a predetermined time Tx. Incidentally, in a normal operation, the printing apparatus is configured so that immediately after the printing operation, the print head 3 may move to right above the capping device 11, go into the standby state, and be ready to shift to the printing operation immediately after a print command comes in. Then, the printing apparatus is configured so that upon a lapse of a predetermined time Tw being in the standby state, it may perform the recovery operation, e.g., the wiping, perform the preliminary ejection, and execute the capping. The above-mentioned predetermined time Tx is set to a time slightly shorter than Tw, e.g., (Tw−1) seconds, in order to especially create a situation where color mixture occurs easily.

Next, printing of an evaluation patch is performed at Step S103. That is, the preliminary ejection is performed to the printing medium while making the print head 3 scan, and the evaluation patch is printed on the printing medium. Printing of this evaluation patch is performed for each color, specifically for each nozzle row except that of black.

The evaluation patch is printed with a sold one pass for each monochrome color, respectively. For example, a print head in which the nozzles are arranged with 256 nozzles per nozzle row at a spacing of 1200 dpi (=21 μm) is used. When an ink droplet (5 pl/shot) is ejected from one nozzle and this ink droplet is impacted on the printing medium, a dot of a diameter of about 20 μm is printed on the printing medium. When performing the printing with a carriage speed in the scanning direction A being set to 12.5 inch/sec (0.32 m/sec) and a drive frequency being set to 15 kHz, a dot arrangement in the scanning direction A becomes such that one dot is embedded in a grid of 1200 dpi. For this reason, the color mixture can be determined suitably, and it is possible to suitably bring a line of chatter in the nozzle surface and the number of preliminary ejections in the nozzle row of each color into correspondence with each other. Incidentally, although a routine of FIG. 5 is for one nozzle row, the routine is repeatedly performed on each nozzle row.

Next, at Step S104, an image of the evaluation patch is scanned by the scanner 9.

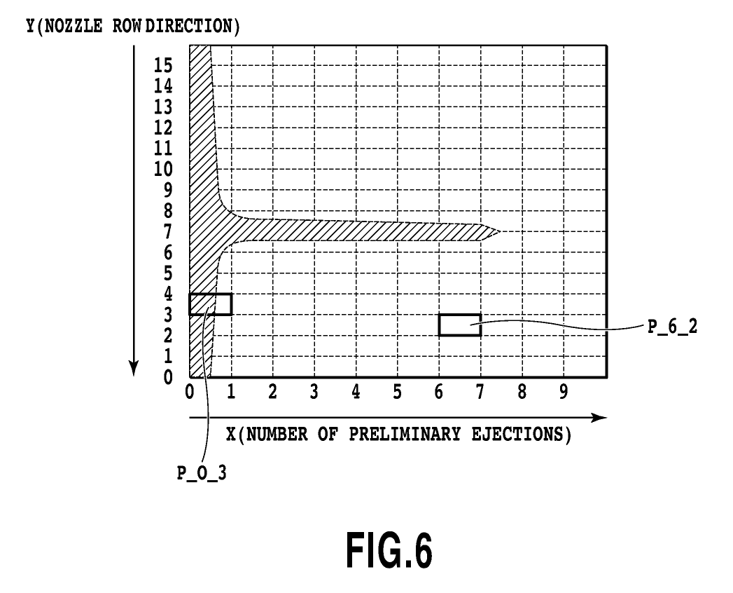

Then, at Step S105, data of the image of the scanned evaluation patch is divided into a plurality of divided areas. FIG. 6 shows an example of the image of the evaluation patch and the divided areas. In an example illustrated, the number of preliminary ejections is on the X-axis, and a nozzle row direction is on the Y-axis. Incidentally, the X-axis is parallel to the scanning direction A, and the Y-axis is in agreement with the vertical scanning direction B. 16 shots are included in an X-axis direction and 16 nozzles are included in a Y-axis direction per divided area. Each divided area is designated by P_x_y. At a later Step S107, existence/absence of the color mixture will be determined for each divided area.

Next, at Step S106, a first divided area P_0_0 (x=0, y=0) is selected. Then, at Step S107, a color mixture determination processing of determining the existence/absence of the color mixture for the selected divided area is performed. Although details of this color mixture determination processing will be explained in full detail later, in the case of existence of the color mixture, a determination result of P_x_y=1 is obtained, and the in the case of the absence of the color mixture, a determination result of P_x_y=0 is obtained.

At the next Step S108, it is determined whether the determination result of Step S107 is P_x_y=1, namely, whether the color mixture exists. If the determination result is P_x_y=1, the number of preliminary ejections will be added to the divided area P_x_y at Step S109. On the other hand, if the determination result is P_x_y=0, namely no color mixture, Step S109 will be skipped.

Although the following will be understood in detail later, in this embodiment, a default or standard number of preliminary ejections per divided area is fixed to zero, and in the case of no color mixture, the number of preliminary ejections is fixed to zero. It is specified that in the case of the existence of the color mixture, a predetermined number of preliminary ejections, e.g., 16 shots, shall be added to the default number of preliminary ejections. However, these values can be decided arbitrarily: for example, it is all right that the default number of preliminary ejections is set to a predetermined value equal to or more than unity, the preliminary ejection(s) of one or more shots are performed even in the case of no color mixture. Moreover, it is also all right that in the case of the existence of the color mixture, an arbitrary number of preliminary ejections other than 16 may be added to the default number of preliminary ejections.

Next, at Step S110, it is judged whether evaluation on 16 nozzles to be objected (this is called one nozzle group) is finished in all the divided areas in the X-axis direction. If the evaluation is not finished, the flow will proceed to Step S111, where unity will be added to the value of X, and the flow will proceed to Step S107. In this way, the evaluation will be performed sequentially in each divided area in the X-axis direction for one nozzle group to be objected.

If it is judged that the evaluation is finished at Step S110, the flow will proceed to Step S112, where it will be judged whether the evaluation is finished in all the divided areas in the Y-axis direction. If the evaluation is not finished, the flow will proceed to Step S113, where unity will be added to the value of y, the value of x will be set to zero, and the flow will proceed to Step S107. In this way, the divided area to be subjected to the evaluation in the X-axis direction is set to the area of x=0 again, and the evaluation is performed sequentially in each of the divided areas in the X-axis direction for the next one nozzle group in the Y-axis direction.

If it is judged that the evaluation is finished at Step S112, a preliminary ejection count decision processing will be finished.

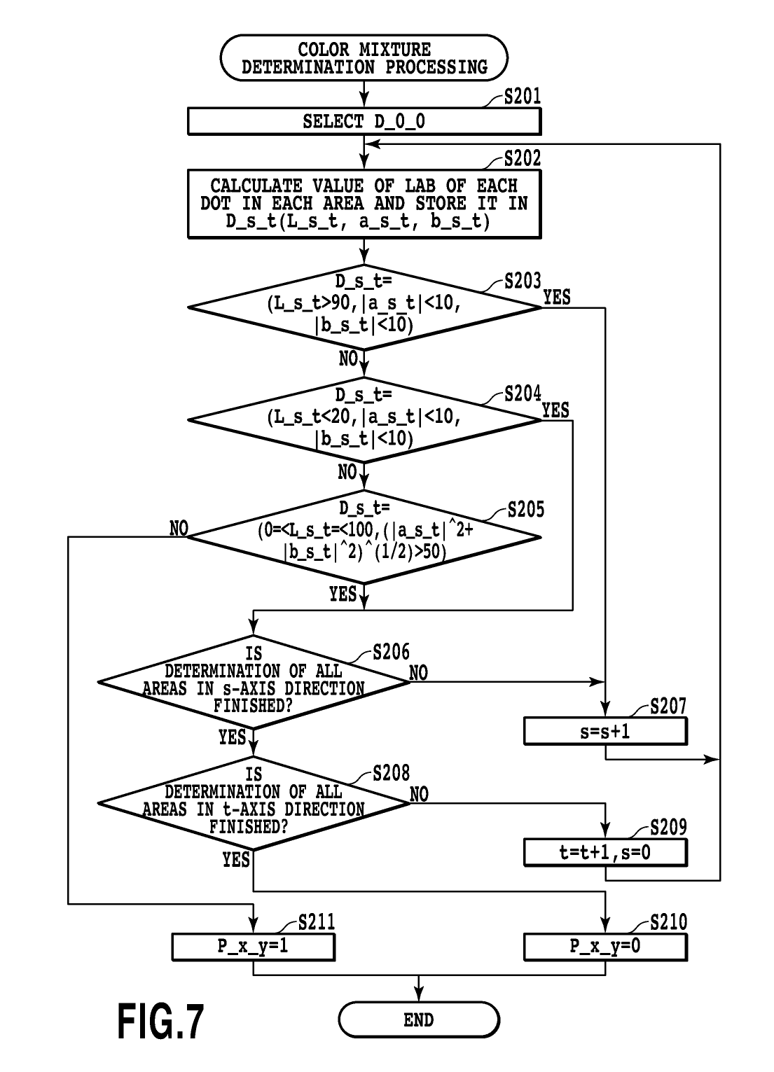

Next, the color mixture determination processing performed at Step S107 will be explained with reference to FIG. 7. This processing is also mainly performed by the CPU 500.

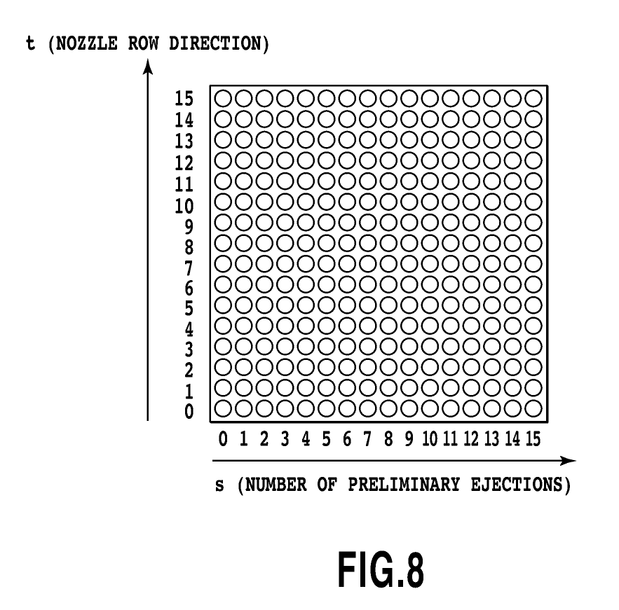

Here, as shown in FIG. 8, one divided area P_x_y is divided still more finely: it is divided into a unit of one shot count and one nozzle. The number of preliminary ejections is on the S-axis and the nozzle row direction is on the t-axis, and each area in the figure is called a dot area, being designated by D_s_t.

As shown in FIG. 7, first, at Step S201, S=0 and t=0 are substituted and a first dot area D_0_0 is selected.

Next, at Step S202, Lab values of each dot area D_s_t are stored in (L_s_t, a_s_t, b_s_t), respectively.

At Step S203, in order to remove a part of the printing medium (paper), it is determined whether Dst satisfies conditions of L_s_t>90, |a_s_t|<10, and |b_s_t|<10, namely whether the lightness is high and the saturation is low. In the case of Yes, that part of the printing medium is regarded as a portion on which the printing is not done, it is excluded from the color mixture determination and the flow moves to Step S207.

If the part is not excluded at Step S203, it is assumed that it is printed, and the flow will proceed to the next Step S204. At Step S204, it is determined whether Dst satisfies the conditions of L_s_t<20, |a_s_t|<10, and |b_s_t|<10, namely whether the lightness is low and the saturation is low. In the case of Yes, it is assumed that the black ink is printed, and the flow moves to Step S206.

In the case of No, at Step S205, it is judged whether D_s_t satisfies conditions of 0≦L_s_t<100, and (|a_s_t|²+|b_s_t|²)(^{1/2})>50) (where “≦” means “=<”), namely where the saturation shows a high value. In the case of Yes, it is assumed that any one of color inks of cyan, magenta, and yellow is printed normally without the color mixture, and the flow moves to Step S206.

On the other hand, at Step S205, in the case of No, it is assumed that what is printed is the mixed color inks whose saturation is low and whose lightness falls somewhere in between high and low. Then, the flow proceeds to Step S211, where the whole of the divided area to which the dot area D_s_t belongs is given P_x_y=1, and a determination that the color mixture exists is performed. That is, if the color mixture is recognized even in one dot area in the one divided area P_x_y, the determination that the color mixture exists is made for the whole of the divided area. Then, the color mixture determination processing is ended.

At Step S206, it is judged in all the dot areas in an S-axis direction whether the determination is finished for one nozzle that is subject to the determination. If the determination is not finished, the flow will proceed to Step S207, where unity will be added to the value of S, and the flow will proceed to Step S202. In this way, for one nozzle to be subjected to the determination, the determination will be performed sequentially in each dot area in the S-axis direction.

If it is judged that the determination is finished at Step S206, the flow will proceed to Step S208, where it will be judged whether the determination is finished in all the dot areas in the t-axis direction. If the determination is not finished, the flow will proceed to Step S209, where unity will be added to the value of t and the value of S will be set to zero, and the flow will proceed to Step S202. In this way, the dot area in the S-axis direction will be set to an area of S=0 again, and the determination will be performed in each dot area in the S-axis direction sequentially for the next one nozzle in the t-axis direction.

If it is judged that the determination is finished at Step S208, the flow will proceed to Step S210, where the whole of the divided area P_x_y to which the dot area D_s_t to be subjected to the determination belongs will be set to P_x_y=0, and a determination of no color mixture will be made. That is, if the color mixture is not recognized in all the dot areas in the one divided area P_x_y, the determination of no color mixture will be made for the whole of the divided area. Then the color mixture determination processing is ended.

Incidentally, in order to perform the determination of the existence/absence of the color mixture, methods other than such a method is applicable. For example, a method of, when the color mixture is observed in dot areas of a predetermined ratio (for example, 30%, 50%, or 70%) or more in the one divided area, determining that the color mixture exists in the divided area is also possible. Furthermore, it is unnecessary to determine whether or not color mixture has occurred for each nozzle and for each dot as in the present embodiment. The size of the determination area may be appropriately set in accordance with conditions such as the resolution of the mounted scanner.

Now, in one example of the evaluation patch shown in FIG. 6, a colored area represents an area where the color mixture exists, and a non-colored area represents an area where no color mixture exists. A monochrome of yellow is used as the ink. The figure shows that an intermediate part in the Y-axis direction forms a color mixture area relatively larger than other parts. Since the X-axis of FIG. 6 can be regarded as a time-axis, the above finding will mean that the nozzle of the intermediate part in the one nozzle row continues ejecting the mixed color inks for a time longer than the nozzles on other parts do. Moreover, as a whole, all the nozzles in the divided area at x=0 eject the mixed color inks. Seeing the printing as time elapses, although at the early stage of the ejection, all the nozzles eject the mixed color inks, after that, only the nozzles in the intermediate part eject the mixed color inks.

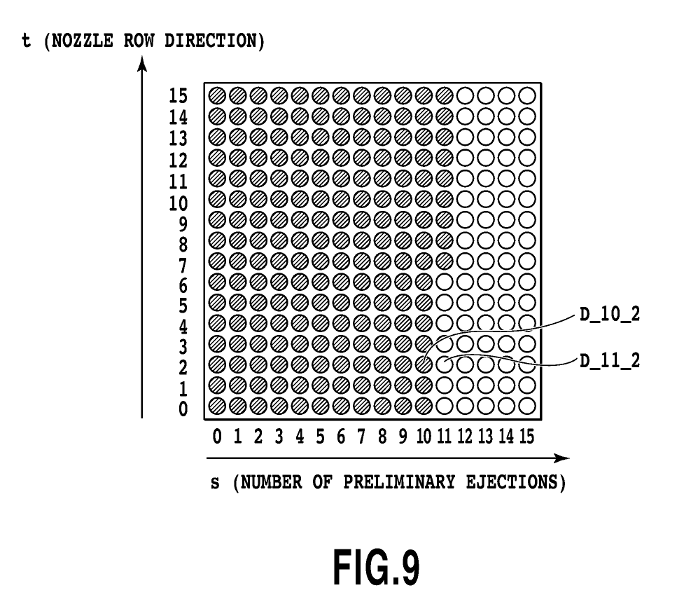

FIG. 8 and FIG. 9 show details of the divided areas P_6_2 and P_0_3 shown in FIG. 6. In FIG. 8 and FIG. 9, a white dot (for example, D_11_2 of FIG. 9) represents a dot or impact when the yellow ink is ejected normally, and a colored dot (for example, D_10_2 of FIG. 9) represents a dot or impact when the mixed color inks are ejected.

In the divided area P_6_2 shown in FIG. 8, since the yellow ink is normally ej ected for all the impacts, a color mixture determination result of P_6_2=0 is obtained. On the other hand, in the divided area P_0_3 shown in FIG. 9, since the mixed color inks were ejected in an area of a left-hand side writing part, a color mixture determination result of P_0_3=1 is obtained.

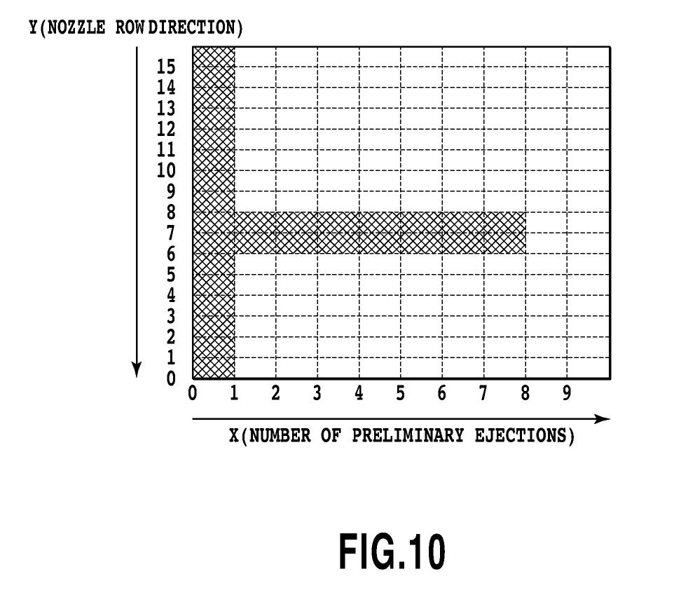

FIG. 10 shows a result of having determined the divided areas P_x_y in this way. A white area is an area of P_x_y=0 and a hatched area is an area of P_x_y=1. This determination result almost agrees with an actual evaluation patch shown in FIG. 6.

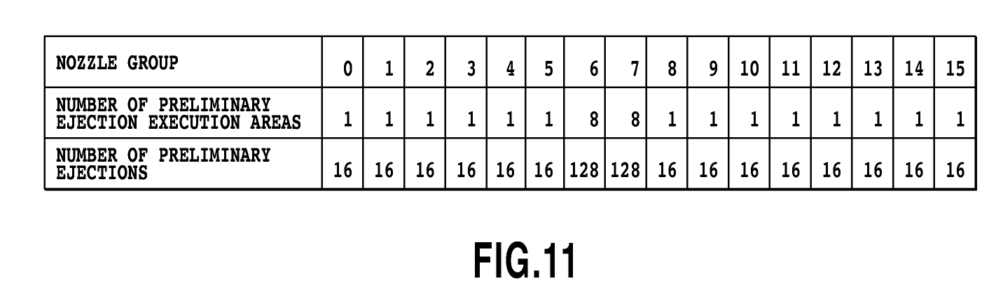

FIG. 11 shows a result that the CPU 500 decided the number of preliminary ejections from the result of FIG. 10. In the figure, the “nozzle group” designates a group of 16 nozzles that are separated from the nozzles in the nozzle row direction. For example, the separation goes as follows: the first 16 nozzles in the nozzle row direction are called a “nozzle group 0”; and the next 16 nozzles are called a “nozzle group 1”. In addition, the nozzle group 0 designates a nozzle group included at y=0 of the divided area of FIG. 6 and the nozzle group 1 designates a nozzle group included at y=1 of the divided area of FIG. 6.

Moreover, in the figure, the “number of preliminary ejection execution areas” means the number of areas where hatching is given in FIG. 10, i.e., the number of areas in which the determination of the existence of the color mixture is done. For example, it is one area for the nozzle group 0, and it is eight areas for the nozzle group 6.

Furthermore, in the figure, “the number of preliminary ejections” means the number of shots that all the nozzles belonging to one nozzle group preliminarily eject. For example, for the nozzle group 0, since the number of preliminary ejection execution areas is one, all the nozzles belonging to the nozzle group 0 perform the preliminary ejection of 1×16=16 shots uniformly. That is, the number of preliminary ejections of 16 shots as one unit is associated to the number of preliminary ejection execution areas of 1. On the other hand, for the nozzle group 6, since the number of preliminary ejection execution areas is eight, all the nozzles belonging to the nozzle group 6 perform the preliminary ejection of 8×16=128 shots uniformly.

For the nozzles of nozzle groups 6, 7 that formed a relatively large color mixture area in the evaluation patch, the number of preliminary ejections is made to increase to a larger number than the nozzles of the nozzle groups 1 to 5 and 8 to 15 that formed relatively small color mixture areas in the same patch. Incidentally, the “relatively small color mixture area” includes an area with no color mixture. Therefore, a large amount of preliminary ejection can be performed for nozzles having a large degree of the color mixture, and a small amount of preliminary ejection can be performed for nozzles having a small degree of the color mixture, so that effective ink consumption can be achieved. Furthermore, since the number of preliminary ejections for each nozzle is decided based on a result of actually printing the evaluation patch by the preliminary ejection, it is possible to appropriately decide the number of preliminary ejections for each nozzle according to the color mixture parts that vary for every apparatus. In this way, it becomes possible to achieve compatibility of an excellent image quality and decrease of the amount of waste inks.

In the present embodiment, description has been given of the method of determining the number of preliminary ejections for the color nozzle rows other than the black nozzle row (cyan, magenta, and yellow). However, even for the black nozzle row, a pattern may be formed so that the number of preliminary ejections can be determined based on the formation results. Processing similar to that described above and shown in FIG. 7 may be used for the black nozzle row. However, for the black nozzle row, the determination in step S204 is opposite to that for the color nozzle rows, and the processing in step S205 is omitted. That is, if the determination in step S204 is YES, both lightness and intensity are low. Thus, the process determines that the black ink has been printed without being mixed with any other color, and proceeds to step S206. On the other hand, the determination in step 204 is NO, color mixture may have occurred in the black nozzle row. The process then proceeds to step S221. Thus, even for the black nozzle row, a pattern may be formed so that the number of preliminary ejections can be determined based on the formation results.

In the foregoing, although the embodiment of the present invention was described in detail, various embodiments of the present invention can be considered other than this.

For example, in the embodiment, the nozzle hole diameters of all the nozzles of all the nozzle rows were identical. On the other hand, it is all right that a plurality of kinds of nozzles each of which has a different nozzle hole diameter may be included in all the nozzles. This includes a case where nozzle hole diameters differ from one another within one nozzle row, and a case where the hole diameters are the same within one nozzle row but the hole diameters differ among the nozzle rows. In such a case, since the larger the nozzle hole diameter of the nozzle, the smaller a capillary force becomes, and consequently the mixed color inks invades more easily into the nozzles. Therefore, when increasing the number of preliminary ejections of a specific nozzle (in the embodiment, the nozzles of the nozzle groups 6, 7), the numbers of preliminary ejections may be increased to a larger number for a nozzle with a larger nozzle hole diameter. For example, consider a case where two kinds of nozzles, larger one and smaller one, in each nozzle group in the embodiment. It can be specified that for larger diameter nozzles among nozzles of the nozzle groups 6, 7, the number of shots is set to 144 (=8×18) shots larger than 128, and for smaller diameter nozzles, the number of shots is set to 128 (=8×16) shots.

Moreover, if the environmental temperature decreases, the viscosity of ink will increase and it will become difficult for the mixed color inks to invade into the nozzle. Therefore, when increasing the number of preliminary ejections of a specific nozzle, the number of preliminary ejections may be increased to a larger number for a higher environmental temperature. In this case, an environmental temperature detecting unit, such as a temperature sensor for detecting the environmental temperature, is provided, and the increased number of preliminary ejections is decided according to this detected temperature.

Moreover, since the nozzle surface dries with decreasing environmental humidity, it becomes difficult for the mixed color inks to invade into the nozzles Therefore, when increasing the number of preliminary ejections of a specific nozzle, the number of preliminary ejections may be increased to a larger number for a higher environmental humidity. In addition, in this case, an environmental humidity detecting unit, such as a humidity sensor for detecting an environmental humidity, is provided and an increased number of preliminary ejections is decided according to this detected humidity.

Furthermore, the above-described preliminary ejection number determination process need not necessarily be carried out after every wiping operation but may be executed after every predetermined number of wiping operations. Furthermore, in the above-described embodiment, the degree of occurrence of color mixture is sensed based on the results of formation of a pattern. However, the sensor may directly detect the status of color mixture on the ejection port surface (nozzle surface). Specifically, after the wiping is carried out, the sensor is used to determine whether or not ink droplets in a mixed color are attached to the ejection port surface. If the process determines that ink droplets in a mixed color are attached to the ejection port surface, then a predetermined time later, the sensor is used again to determine whether or not ink droplets in the mixed color are attached to the ejection port surface. If no ink droplets in the mixed color can be detected any longer, the process may determine that the mixed color ink has entered the nozzle. Then, in the subsequent preliminary ejection, the amount of preliminary ejection to the vicinity of the attached ink may be increased.

Moreover, although in the embodiment, the image of the evaluation patch was scanned by the scanner and the existence/absence of the color mixture was determined, it is all right that the user performs the determination by visual inspection. In this case, for example, the user inputs an area with the color mixture and an area without the color mixture using keys etc. of the operation panel 506 based on the image in the evaluation patch. Then, correspondingly to this input, the CPU 500 appropriately decides the number of preliminary ejections for each nozzle similarly to what was described above, and stores it in the RAM 502.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-287540, filed Dec. 18, 2009, which is hereby incorporated by reference herein in its entirety.

What is claimed is:

1. An ink jet printing apparatus including:
a printing section configured to perform printing using a print head with a plurality of nozzle rows formed in a nozzle surface and through which ink in different colors is ejected;
a wiping device configured to wipe the nozzle surface in the print head;
a preliminary ejection unit configured to preliminarily eject ink from the print head;
a patch printing unit configured to print an evaluation patch on a print medium using a predetermined one of the plurality of nozzle rows after the wiping is carried out; and
a determination unit configured to determine the number of preliminary ejections for every predetermined number of nozzles in the predetermined nozzle row based on the evaluation patch.

2. The inkjet printing apparatus according to claim 1, wherein the determination unit sets the number of preliminary ejections through a nozzle involving the evaluation patch with a relatively high degree of occurrence of color mixture to be larger than the number of preliminary ejections through a nozzle involving the evaluation patch with a relatively low degree of occurrence of color mixture.

3. The inkjet printing apparatus according to claim 1, wherein the evaluation patch with the relatively high degree of occurrence of color mixture includes a relatively large color mixture area, and the evaluation patch with the relatively low degree of occurrence of color mixture includes a relatively small color mixture area.

4. The inkjet printing apparatus according to claim 1, further comprising:
a scanner for scanning an image of the evaluation patch; and
a color mixture determination unit for determining existence/absence of color mixture for each divided area of the image based on data of the image scanned by the scanner.

5. The inkjet printing apparatus according to claim 1, wherein the predetermined nozzle row includes a nozzle with a different nozzle diameter, and
the determination unit sets the number of preliminary ejections through a nozzle in which the nozzle diameter is relatively large, to be larger than the number of preliminary ejections through a nozzle in which the nozzle diameter is relatively small, in a case where degrees of occurrence of color mixture are equal.

6. The inkjet printing apparatus according to claim 1, further comprising an environmental temperature detecting unit for detecting an environmental temperature,
wherein the determination unit sets the number of preliminary ejections to be larger as the environmental temperature detected by the environmental temperature detecting unit is higher, in a case where degrees of occurrence of color mixture are equal.

7. The inkjet printing apparatus according to claim 1, further comprising an environmental humidity detecting unit for detecting an environmental humidity,
wherein the determination unit sets the number of preliminary ejections to be larger as the environmental humidity detected by the environmental humidity detecting unit is higher, in a case where degrees of occurrence of color mixture are equal.

8. A recovery method of recovering an ink ejection state of a print head with a plurality of nozzle rows formed in a nozzle surface and through which ink in different colors is ejected, the method including:
wiping the nozzle surface in the print head with a wiping device;
after the wiping, printing an evaluation patch on a print medium using a predetermined one of the plurality of nozzle rows; and
based on the number of preliminary ejections determined based on the evaluation patch, carrying out a preliminary ejection for every predetermined number of nozzles in the predetermined nozzle row.
